(19) United States
(12) Patent Application Publication
(10) Pub. No.: US 2016/0088584 A1
(43) Pub. Date: Mar. 24, 2016

(54) Methods and Apparatuses for Efficient Learning of Unknown Access Point Location Using Trilateration Based on Multi-Resolution

(71) Applicant: QUALCOMM Incorporated, San Diego, CA (US)

(72) Inventors: Shrinivas Shrikant KUDEKAR, Somerville, NJ (US); Ravi PALANKI, Cupertino, CA (US); Thomas Joseph RICHARDSON, IV, South Orange, NJ (US)

(21) Appl. No.: 14/491,723

(22) Filed: Sep. 19, 2014

(51) Int. Cl. H04W 64/00; H04W 4/04

(52) U.S. Cl. CPC H04W 64/003; H04W 4/04; H04W 88/08

(57) ABSTRACT

Methods and systems are presented for estimating a location of an access point (AP) associated with an indoor environment. In some embodiments a method includes obtaining a coarse set of signal information associated with the indoor environment. The method may also include obtaining ranging measurements based on signals received from the AP, computing at least one coarse location estimate of the AP based on the received coarse set of signal information and the ranging measurements, receiving a fine set of signal information associated with the at least one coarse location estimate of the AP, and computing at least one fine location estimate of the AP based on the received fine set of signal information and the ranging measurements, wherein the at least one fine location estimate of the AP is more accurate than the at least one coarse location estimate of the AP.

### BACKGROUND

The present disclosures generally relate to estimating a location of an access point (AP) in an indoor environment.

An AP whose location is “unknown” or “undocumented” may be a fairly common occurrence, and one that is desirable to remedy. For example, new APs may be added to an existing indoor network of APs periodically, or in other cases, a map of APs in an indoor environment may not contain the locations of all APs in said environment. It may be desirable to determine the locations of the unknown APs in order to utilize the APs for indoor positioning purposes, as indoor positioning techniques often rely on an assumption that the locations of the APs are known and reliable.

### BRIEF SUMMARY

Methods and systems are presented for estimating a location of an access point (AP) associated with an indoor environment. An example method for estimating a location of an access point (AP) associated with an indoor environment, according to the disclosure, includes obtaining a first set of signal information associated with the indoor environment, obtaining a received signal strength indication (RSSI) measurement based on signals received from the AP, and computing a first location estimate of the AP based on the first set of signal information and the RSSI measurement. The method further includes obtaining a second set of signal information associated with the first location estimate of the AP, and computing a second location estimate of the AP based on the second set of signal information and the RSSI measurement, where second location estimate of the AP is more accurate than the first location estimate of the AP.

The example method can include one or more of the following features. The method can include: (a) in response to computing a previous location estimate of the AP, receiving a set of signal information that is associated with the previous location estimate of the AP, (b) computing a location estimate of the AP that is more accurate than the previous location estimate, based on the set of signal information received in (a); and (c) repeating (a) and (b) until it is determined that the location estimate of the AP computed in (b) is sufficiently accurate, based on a predetermined threshold criterion. The first set of signal information and the second set of signal information both can include information regarding walls, line-of-sight, and non-line-of-sight characteristics of the indoor environment. The method can include sending the second location estimate to a location server. The first set of signal information can include information related to a first area associated with the indoor environment, and the second set of signal information can include information related to a second area associated with the indoor environment, and the first area can be larger than the second area and fully encompasses the second area. The first set of signal information can include signal information from a plurality of signaling centroids, the plurality of signaling centroids each positioned at different locations within the indoor environment. The plurality of signaling centroids can be arranged in a grid-like pattern.

An example mobile device configured to estimate a location of an access point (AP) within an indoor environment, according to the disclosure, includes a transceiver configured to obtain a first set of signal information associated with the indoor environment, obtain a received signal strength indication (RSSI) measurement based on signals received from the AP, and receive a second set of signal information associated with a first location estimate of the AP. The mobile device further includes a processor configured to compute the first location estimate of the AP based on the first set of signal information and the RSSI measurement, and compute a second location estimate of the AP based on the second set of signal information and RSSI measurement, where the second location estimate of the AP is more accurate than the first location estimate of the AP.

The example mobile device can include one or more of the following features. The transceiver can be further configured to (a) in response to a computation of a previous location estimate of the AP, receive a set of signal information that is associated with the previous location estimate of the AP, and the processor is further configured to (b) compute a location estimate of the AP that is more accurate than the previous location estimate, based on the set of signal information received in (a). The mobile device is further configured to repeat (a) and (b) until it is determined that the location estimate of the AP computed in (b) is sufficiently accurate, based on a predetermined threshold criterion. The first set of signal information and the second set of signal information both can include information regarding walls, line-of-sight, and non-line-of-sight characteristics of the indoor environment. The transceiver can be further configured to send the second location estimate to a location server. The first set of signal information can include information related to a first area associated with the indoor environment, and the second set of signal information can include information related to a second area associated with the indoor environment, and the first area can be larger than the second area and fully encompasses the second area. The first set of signal information can include signal information from a plurality of signaling centroids, the plurality of signaling centroids each positioned at different locations within the indoor environment. The plurality of signaling centroids can be arranged in a grid-like pattern.

An example method of facilitating location estimation of an access point (AP) associated with an indoor environment, according to the disclosure, includes sending, to a mobile device, a first set of signal information associated with the indoor environment, receiving, in response to the first set of signal information, a first message from the mobile device, sending, to the mobile device, a second set of signal information associated with the indoor environment, based on the first message from the mobile device, and receiving, from the mobile device and subsequent to sending the second set of signal information, a location estimate of the AP.

The example method can include one or more of the following features. (a) receiving an additional message from the mobile device subsequent to the sending of a previous set of signal information associated with the indoor environment, and (b) sending, to the mobile device, an additional set of signal information associated with the indoor environment, based on the additional message from the mobile device, wherein both (a) and (b) occur after sending the second set of signal information, and prior to receiving the location estimate of the AP. (a) and (b) can be repeated until it is determined that the location estimate of the AP computed in function (b) is sufficiently accurate, based on a predetermined threshold criterion. The first set of signal information and the second set of signal information both can include information regarding walls, line-of-sight, and non-line-of-sight characteristics of the indoor environment. The first message comprises either or both of an initial location estimate of the AP, or a request for the second set of signal information. The first set of signal information can include information related to a first area associated with the indoor environment, and the second set of signal information can include information related to a second area associated with the indoor environment, and the first area is larger than the second area and fully encompasses the second area. The first set of signal information can include signal information from a plurality of signaling centroids, the plurality of signaling centroids each positioned at different locations within the indoor environment. The plurality of signaling centroids can be arranged in a grid-like pattern.

An example server configured to facilitate location estimation of an access point (AP) associated with an indoor environment, according to the disclosure, can include a transceiver, a memory; and one or more processors communicatively coupled with the transceiver and the memory. The one or more processors are configured to cause the server to send, to a mobile device, a first set of signal information associated with the indoor environment, receive, in response to the first set of signal information, a first message from the mobile device, send, to the mobile device, a second set of signal information associated with the indoor environment to the mobile device, based on the first message from the mobile device, and receive, from the mobile device and subsequent to sending the second set of signal information, a location estimate of the AP.

The example server can include one or more of the following features. The one or more processors can be configured to cause the server to (a) receive an additional message from the mobile device subsequent to the sending of a previous set of signal information associated with the indoor environment, and (b) send, to the mobile device, an additional set of signal information associated with the indoor environment, based on the additional message from the mobile device, where both (a) and (b) occur after sending the second set of signal information, and prior to receiving the location estimate of the AP. The one or more processors can be configured to cause the server to repeat (a) and (b) until it is determined that the location estimate of the AP computed in function (b) is sufficiently accurate, based on a predetermined threshold criterion. The one or more processors can be configured to cause the server to send the first set of signal information and the second set of signal information comprising information regarding walls, line-of-sight, and non-line-of-sight characteristics of the indoor environment. The one or more processors can be configured to cause the server to base the second set of signal information on the first message comprising either or both of an initial location estimate of the AP, or a request for the second set of signal information. The one or more processors can be configured to cause the server to include, in the first set of signal information, information related to a first area associated with the indoor environment; and include, in the second set of signal information, information related to a second area associated with the indoor environment, wherein the first area is larger than the second area and fully encompasses the second area. The one or more processors can be configured to cause the server to include, in the first set of signal information, signal information from a plurality of signaling centroids, the plurality of signaling centroids each positioned at different locations within the indoor environment. The one or more processors can be configured to cause the server to further cause the plurality of signaling centroids to be arranged in a grid-like pattern.

### BRIEF DESCRIPTION OF THE DRAWINGS

An understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 is an example mobile device for implementing some aspects of the present disclosures.

FIG. 2 illustrates an example layout of an indoor environment associated with methods according to some embodiments.

FIG. 3 illustrates another example layout of the indoor environment associated with methods according to some embodiments.

FIG. 4A illustrates an example method for estimating a location of an access point, according to some embodiments.

FIG. 4B illustrates another example method for estimating a location of an access point, according to some embodiments.

FIG. 5 illustrates another example method for estimating a location of an access point, according to some embodiments.

FIG. 6 illustrates an example computer system, according to some embodiments.

### DETAILED DESCRIPTION

Several illustrative embodiments will now be described with respect to the accompanying drawings, which form a part hereof. While particular embodiments, in which one or more aspects of the disclosure may be implemented, are described below, other embodiments may be used and various modifications may be made without departing from the scope of the disclosure or the spirit of the appended claims.

Methods and systems are presented for estimating a position of an access point (AP) whose location is unknown or undocumented. An AP whose location is “unknown” or “undocumented” in this sense may refer to an AP being in range of a location server (hereinafter, a “server”) or centralized processor, such that the server can receive wireless information from the AP, but the server does not know the exact or substantially precise location of the AP. For example, new APs may be added to an existing indoor network of APs periodically, or in other cases, a map of APs in an indoor environment may not contain the locations of all APs in said environment. It may be desirable to determine the locations of the unknown APs in order to utilize the APs for indoor positioning purposes, indoor positioning techniques often rely on an assumption that the locations of the APs are known and reliable.

There exist a number of methods for searching for the locations of these “undocumented” APs, but older techniques may be quite inefficient from a time and energy standpoint. For example, a classic solution to finding unknown APs, sometimes called fingerprinting, is to tabulate signal strength measurements of the unknown AP at essentially every space in the indoor environment, e.g., obtain measurements at every square foot, then determine that the AP is at the location with the strongest signal strength measurement. Fingerprinting can be very slow and energy intensive, since hundreds or even thousands of signal strength measurements may be required. Fingerprinting can be distributed among many user devices, e.g. mobile phones, via crowdsourcing techniques to improve the speed and to distribute power usage among multiple devices. However, another problem arises when utilizing user devices is that often times the user device must provide metadata, location data, and other data that potentially infringes on the user's privacy.

Aspects of the present disclosure provide a more efficient—both from a time and energy standpoint—and more private solution for estimating the position of APs whose locations are unknown. According to some embodiments, this process generally involves a series of iterative information exchanges between a surveyor device, e.g., a mobile phone, and a server or machine capable of providing to the surveyor device existing information about the indoor environment.

In some embodiments, the surveyor device initially receives a “coarse” set of information about the indoor environment from the server. The coarse set of information may include information about a sparse set of points in and around the indoor environment, often times covering a wide area of the indoor environment, if not the entire area. The surveyor device uses this coarse information, combined with signal strength measurements received from the unknown AP, to generate a “coarse” location estimate of the unknown AP. “Coarse” information as used herein may refer to information that is wider and/or broader in physical area, but is also sparser and/or less detailed. The surveyor device may then send the coarse estimated location of the unknown AP to the server. In some embodiments, multiple coarse estimates may be sent to the server. In response, the server may then send a narrower and/or more detailed “fine” set of information about the indoor environment that is more closely associated with the coarse location estimate(s) of the unknown AP. In some embodiments, the surveyor device may request a fine set of information (e.g., information about a smaller physical area) without providing a coarse estimate. In some embodiments, this “fine” set may contain only information closer in physical proximity to the coarse location estimate(s) of the unknown AP. In this way, the surveyor device essentially narrows its search of the unknown AP by receiving only information more closely related to the unknown AP. The surveyor device then uses this “fine” information, combined with ranging measurements from the unknown AP, to generate a “fine” location estimate of the unknown AP, wherein the “fine” location estimate of the unknown AP is more precise than the “coarse” location estimate.

In some embodiments, this process of sending to the server ever more precise estimates and receiving back ever more closely-related information to the unknown AP, can be repeated in a series of iterations some pre-determined number of times, or until some threshold criterion of precision is reached, e.g., stop iterating when the estimated location does not change more than one square foot from the last iteration.

In some embodiments, a single position estimate may be provided by the surveyor device after cycling through a process of calculating an estimated location and receiving increasingly more precise information (e.g., after reaching a threshold level of preciseness, cycling through the process a certain number of times, etc.).

Advantages of the present disclosures may include, but are not limited to, sending and receiving minimal amounts of signal information, i.e. starting with coarse information and then narrowing the information only to where the unknown AP is more likely to be, as compared to a more exhaustive fingerprinting solution. Additionally, privacy of the surveyor device is maximized, as the surveyor device transmits only estimated locations of the unknown AP, as opposed to needing to send metadata about the surveyor device, or even simply the location of the surveyor device.

These concepts and related embodiments will be discussed in more detail, below.

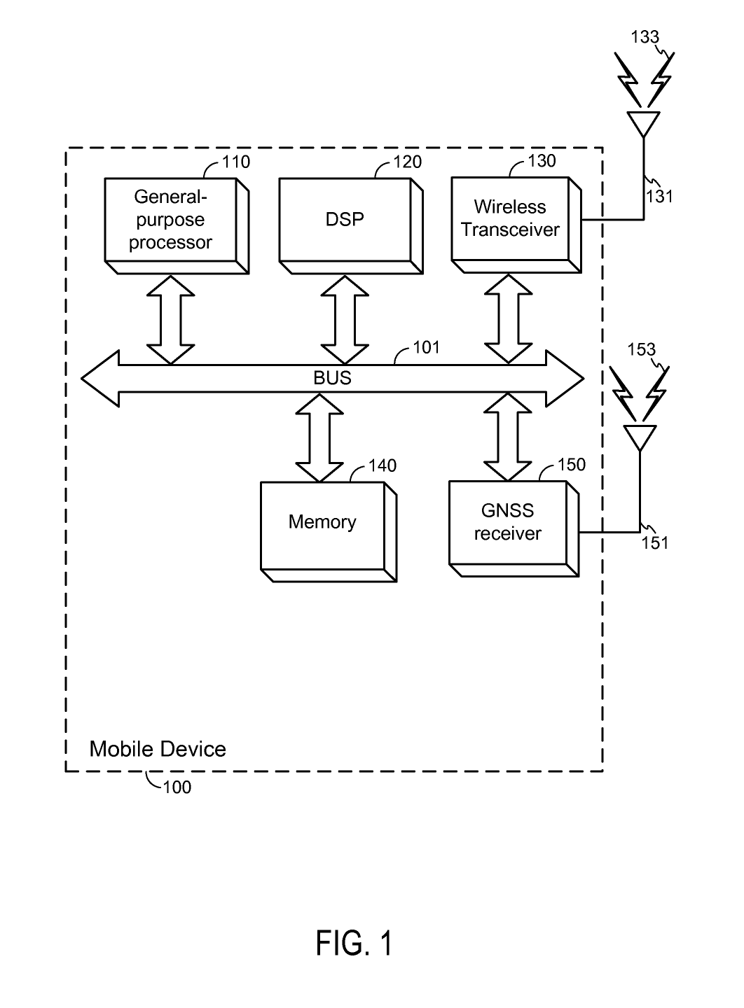

Referring to FIG. 1, an example mobile device 100 used to implement some aspects of the present disclosure is presented. Mobile device 100 may include a general purpose processor 110, a digital signal processor 120, a wireless transceiver 130, memory 140 and global navigation satellite system (GNSS) receiver 150, connected through bus 101. Mobile device 100 may include other components, such as a display screen and user input devices, not shown. The wireless transceiver 130 may be operable to receive a wireless signal 133 via antenna 131. Wireless transceiver 130 via antenna 131 may be configured to receive various radio frequency (RF) signals 133 from one or more APs. The wireless signal 133 may be transmitted by an AP or a server facilitating communications between multiple APs, via a wireless network. In some embodiments, the wireless network may be any wireless network such as a wireless LAN (WLAN) such as WiFi, a Personal Access Network (PAN), such as Bluetooth™ or Zigbee™, or a cellular network (e.g. a GSM, WCDMA, LTE, CDMA2000 network). Wireless transceiver 130 may also be configured to transmit wireless signals to other entities, such as a server or AP operable to receive wireless signals. These signals may be contain request information from the server or AP, or may contain other information in response to a request received from the server or AP. Mobile device 100 may also receive GNSS wireless signals 153 via antenna 151. Mobile device 100 may be configured to obtain information about its own location and/or of the locations of, via wireless transceiver 130 and/or GNSS receiver 150. This information may come in various forms, including ranging information, such as received signal strength indicator (RSSI) measurements, round trip time (RTT) measurements, 2-dimensional or 3-dimensional coordinates, or other types of formats known to those with skill in the art, for APs. Mobile device 100 may be configured to measure multiple sets of ranging information for multiple APs. Mobile device 100 may be configured to process the wireless signals 133, in whole or in part, and/or calculate the location of the mobile device 100. In some embodiments, general-purpose processor(s) 110, memory 140, DSP(s) 120, and specialized processors (not shown) may also be utilized to process the GNSS signals 153, in whole or in part, and/or calculate the location of the mobile device 100, in conjunction with GNSS receiver 150. The storage of GNSS or other location signals may be done in memory 140 or other registers (not shown).

A mobile device 100 can also be called a system, subscriber unit, subscriber station, mobile station, mobile, remote station, remote terminal, user terminal, terminal, mobile terminal, wireless device, wireless terminal, wireless communication device, user agent, user device, Secure User Plane (SUPL) Enabled Terminal (SET) or user equipment (UE), or other terminology known in the art. A mobile device can be a cellular telephone, a cordless telephone, a smartphone, a Session Initiation Protocol (SIP) phone, a wireless local loop (WLL) station, a personal digital assistant (PDA), a handheld device having wireless connection capability, a computing device, a laptop, a tablet or other processing device connected to or containing a modem, for example, a wireless modem, or other related devices known in the art.

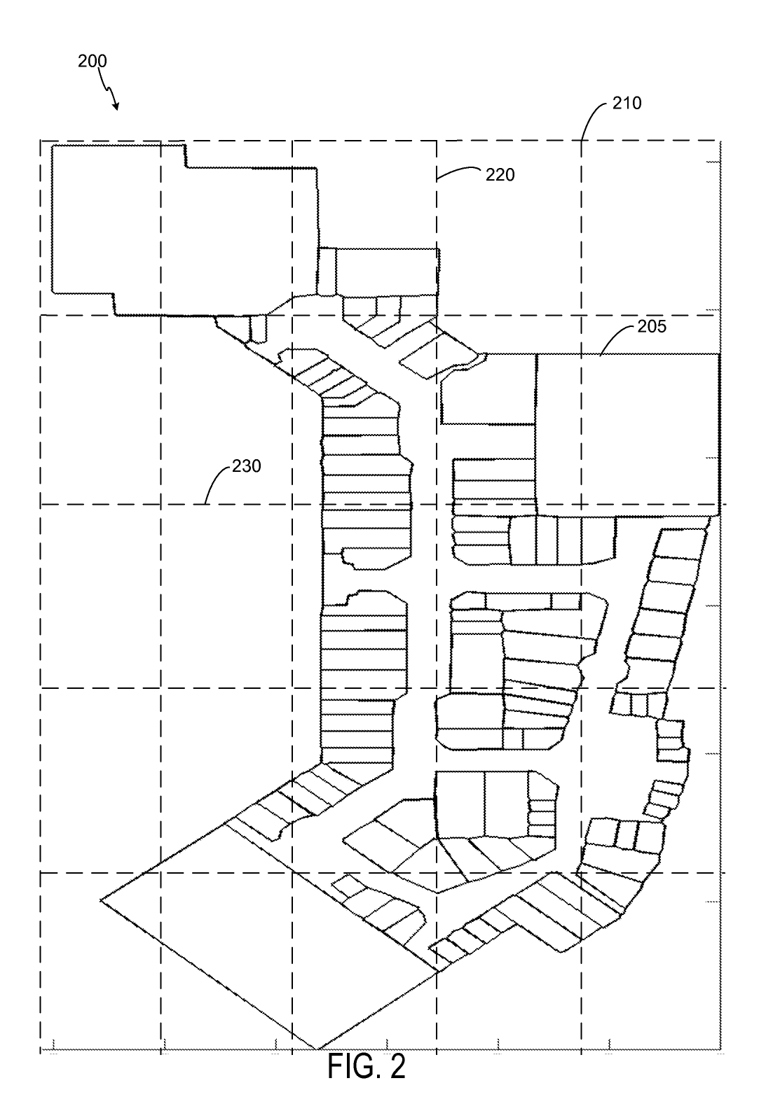

Referring to FIG. 2, overhead map 200 illustrates an example depiction of utilizing a coarse set of signal information, according to some embodiments. Overhead map 200 may illustrate the indoor layout of a building, such as the first floor of an indoor mall 205. Here, the mall 205 is divided into a 5×5 grid 210, shown by the dotted vertical lines, such as line 220, and horizontal lines, such as line 230. A shopper in the mall may be carrying a mobile device 100 that may passively serve as a surveyor device for determining the location of an unknown AP. A server with knowledge of signal information about the mall, such as server, may send, to the surveyor device, such as mobile device 100, signal information about the mall. For example, the server may send signal information from the perspective of each center of the 5×5 rectangles (i.e. from the “centroid” of each of the 5×5 rectangles), for a total of only 25 sets of signal information. The signal information may include layout information about the walls, line of sight (LoS) information, and non-line of sight (NLoS) information, that would be important for interpreting the signal strength information being received from the unknown AP. This set of information from the 25 centroids can be designated as “coarse” signal information, because the centroids span a large area, i.e. the entire mall, and lack finer detail over that entire area. The surveyor device may then generate a “coarse” location estimate of the unknown data using the “coarse” signal information and the ranging measurements from the unknown AP. For example, the surveyor device may determine that the unknown AP is probably located within one of only 4 of the 25 rectangles of the initial 5×5 grid 210. An example of ranging measurements from the unknown AP may be received signal strength indicator (RSSI) measurements.

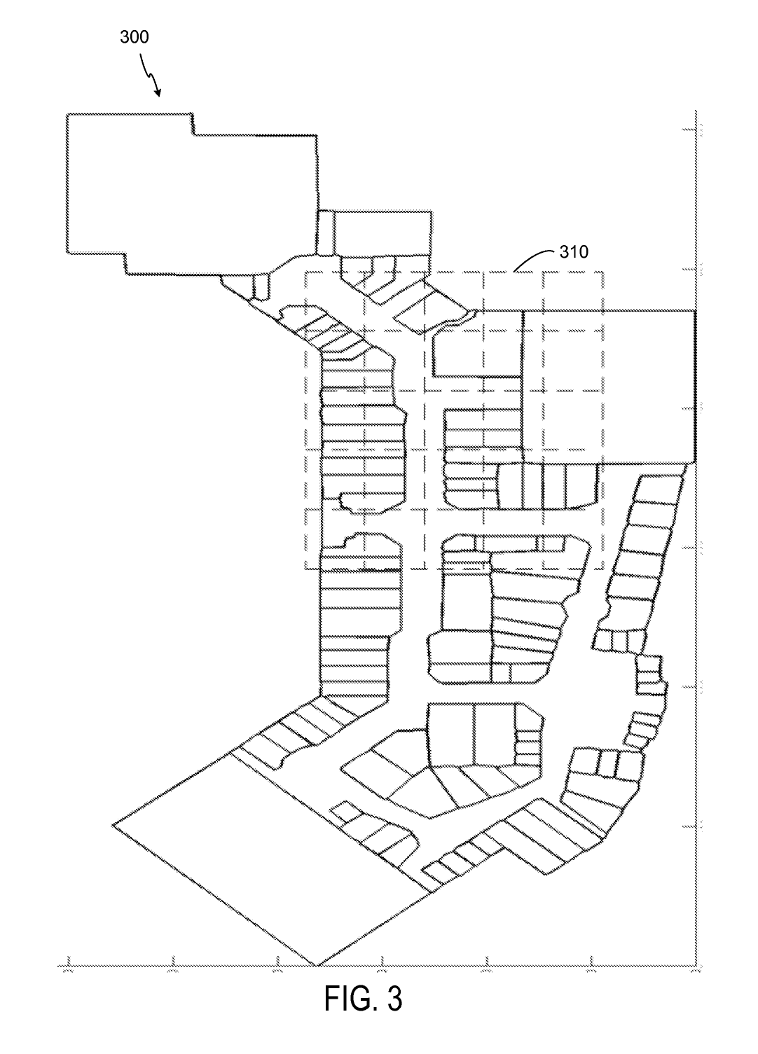

Referring to FIG. 3, illustration 300 shows a subsequent function after the surveyor device determines a coarse location estimate of the AP. Here, the surveyor device may then transmit to the server the coarse location estimate, i.e. just the 4 out of 25 regions. In response, the server may then send to the surveyor device a “fine” set of signal information that relates more closely to this coarse location estimate. In some embodiments, rather than sending the coarse location estimate to the server, the surveyor device can simply request the “fine” set of signal information that relates more closely to the coarse location estimate (e.g., boundaries or another indication of an area for which additional signal information is requested). This is represented by the smaller 5×5 grid 310 shown in FIG. 3. It is noted that in some embodiments, the grid 310 may be considered as a “zoomed-in” version of the larger, coarse grid 210. That is, in some embodiments, the location of the finer grid 310 may be fully encompassed by the location of the coarse grid 210 (i.e., the finer grid 310 can be a subset of the coarse grid 210). The centroids of each square in this smaller 5×5 grid 310 may then be used to calculate a “fine” location estimate of the unknown AP. In some embodiments, the surveyor device can send this fine location estimate back to the server and receive an ever finer and narrower set of signal information (or, alternatively, request the finer set of signal information with or without providing the fine location estimate), corresponding to the fine location estimate, in yet another iteration of methods of the present disclosure. This iterative process can continue some set number of times (e.g. 4, 8, 10 times), or the process can stop after some threshold criteria is reached, e.g., the resolution of the signal information relates to only a single square foot region of the mall, or the change in the estimated location of the AP from one iteration to the next is not more than one meter. After this iterative process ends, the surveyor device can send to the server its final, best location estimate of the unknown AP.

In some embodiments, the example process described in FIGS. 2 and 3 can be crowd-sourced to multiple surveyor devices. For example, the server can send to a first surveyor device a coarse set of signal information. The server can then receive from the first surveyor device a coarse location estimate of the unknown AP based on this coarse signal information. The server can then send to a second surveyor device a fine set of signal information based on the received coarse location estimate of the unknown AP. The server can then receive from the second surveyor device a fine location estimate of the unknown AP. The server can repeat this process with multiple surveyor devices until some threshold criteria is reached, such as if the received location estimates from the surveyor devices converges to within one square foot space of the mall. As another example, multiple surveyor devices can receive coarse signal information, and each can subsequently determine a coarse location estimate of the AP. The server may then collect the multiple coarse location estimates to get a more precise first estimate, before sending a fine set of signal information to the same or different surveyor devices. In general, each iteration could have one or more surveyor devices participating, and embodiments are not so limited.

Additionally, the types and locations of the signal information within each grid, e.g. grid 210 or 310, can vary according to different embodiments. For example, multiple points of signal information within each rectangle may be transmitted to the surveyor device. For example, rather than the centroid within each rectangle, the intersecting points between the horizontal and vertical lines may be transmitted, resulting in 36 points of information rather than 25. In other cases, rectangles that fall completely outside of the known boundaries of the indoor space may be disregarded, since it can be reasoned that the AP is not located outside the building. Similarly, if the centroid of a rectangle falls outside of the indoor space, then the closest point to the centroid but within the indoor space may be transmitted, or some other variant, and embodiments are not so limited.

It should also be noted that privacy of the user and the user's mobile device may be preserved based on these methods, according to some embodiments. This is at least because the only information transmitted from the surveying mobile devices is the location estimate computed based on the latest set of signal information. The mobile device's location does not need to be transmitted, nor does any metadata about the mobile device need to be transmitted. Based on simply an estimated location provided to the server, the server can send back to the mobile device—or send to another mobile device—a set of signal information that is more tailored to the actual location of the AP.

The iterative approach described in FIGS. 2 and 3 may also be expressed in mathematical and algorithmic terms in the following example description. As a preliminary matter, RSSI measurements can be described according to the following equation:

Pᵣ=θ+θ_{direct} ln d_{direct}+θ_{indirect} ln d_{indirect}+θ_{wall} ln(n_{wells})+w

where Pᵣ is the received power, θ is the transmitted power, θ_{direct} is the LoS path loss exponent, θ_{indirect} is the NLoS path loss exponent and θ_{wall} is the wall loss factor. Noise may be modeled as additive white Gaussian random variable with mean zero and standard deviation σ. These parameters as well as the noise power may be known either by prior training or via some crowdsourcing. Note that the coefficient of all the parameters is a function of the point on the floor and the location of the AP. According to the above expression of the received power, it may be difficult to determine the location of the AP via solving a least squares problem. More precisely, the location of the unknown AP may be given by the solution of the following optimization problem,

\hat{s}=argmax_{sεfloor}Πₜ₌₁^{N}p(Pᵣ|s;θ)

Where θ is the known vector of parameter values. The above is equivalent to,

$$\hat{s} = {argmin}_{s ∈ floor} {\sum }_{i = 1}^{N} {( {P}_{r} - ( θ + {θ}_{direct} ln {d}_{direct} + {θ}_{indirect} ln {d}_{indirect} + {e}_{wall} ln ( {n}_{walls} ) ) )}^{2}$$

$$\hat{s} = {argmin}_{s ∈ floor} {\sum }_{i = 1}^{N} {( {P}_{r} - ( θ + {θ}_{direct} ln {d}_{direct} + {θ}_{indirect} ln {d}_{indirect} + {θ}_{wall} ln ( {n}_{walls} ) ) )}^{2}$$

Where the unknown position s occurs implicitly in d_{direct}, d_{indirect} and n_{walls}.

An algorithm to solve this optimization problem is as follows.

Recall that the above minimization problem is over all points on the floor. This could be extremely large if one considers a large scale mall. So it would be prohibitively expensive to solve the minimization problem on the mobile device.

To address the above problem, the floor may be divided into a fixed number of regions (the number of regions are kept small; one could use a simple strategy like 4 equidistant horizontal lines and 4 equidistant vertical lines cutting across the entire floor to create 25 regions), e.g. in a grid-like fashion as shown in FIG. 2. Thus, this process may be referred to as a “gridding strategy.”

Then, a mobile device (e.g., a surveyor device) requests the central server for the d_{direct}, d_{indirect} and n_{walls} of each point on the floor with respect to the centroid of the above mentioned regions. This information may be on the order of a couple of megabytes and hence reduces the overhead of communication with the central server. Indeed, if the AP location is not known we would require the d_{direct}, d_{indirect} and n_{walls} information for all the points on the floor which could be a very large number. With the “gridding strategy” this information may be reduced to 25 points, for example.

The mobile device may then solve the above minimization problem for this set of points (e.g. 25 of them) using, for example, known linear programming techniques according to operations research theory. The mobile device, after solving the minimization problem, then finds out the best solution. I.e., it finds out the set of points which minimizes the cost function:

Σₜ₌₁^{N}=(Pᵣ−(θ+θ_{direct} ln d_{direct}+θ_{indirect} ln d_{indirect}+θ_{wall} ln(n_{walls})))².

It is highly likely that there is just one such point. If there are several, then one can combine the regions associated to the set of best points to form a bigger region.

The approach then involves, further gridding, via the “gridding strategy,” the region formed in the previous paragraph (e.g., determining the fine grid of FIG. 3). The mobile device can then ask for the relevant information for the centroids of the resulting regions. This ping-pong, iterative style of communication between the mobile device and the central server may occur for a fixed number of times, after which the AP location is determined by the mobile device to a reasonable accuracy and can be then crowdsourced to the central server.

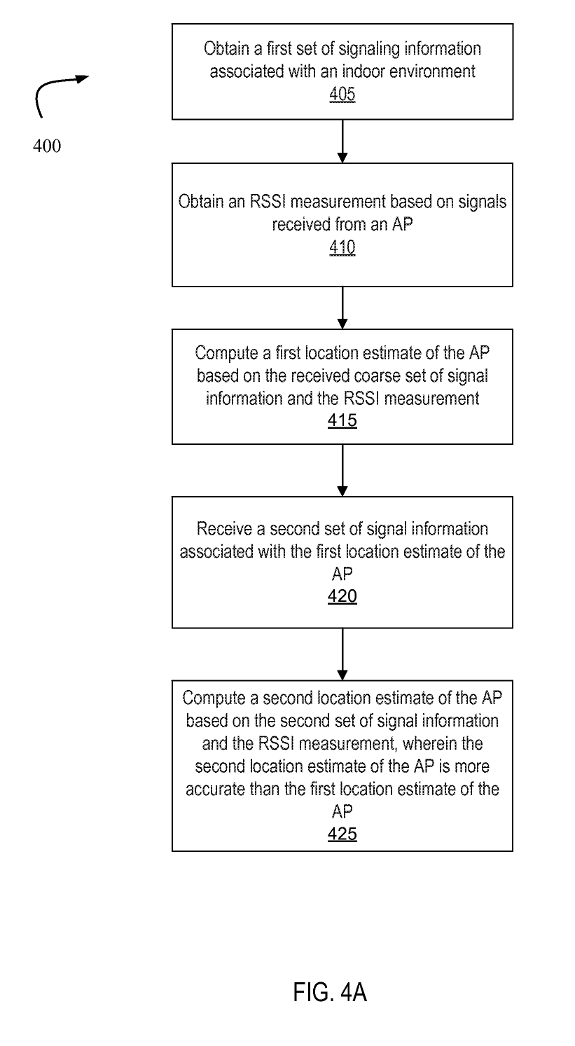

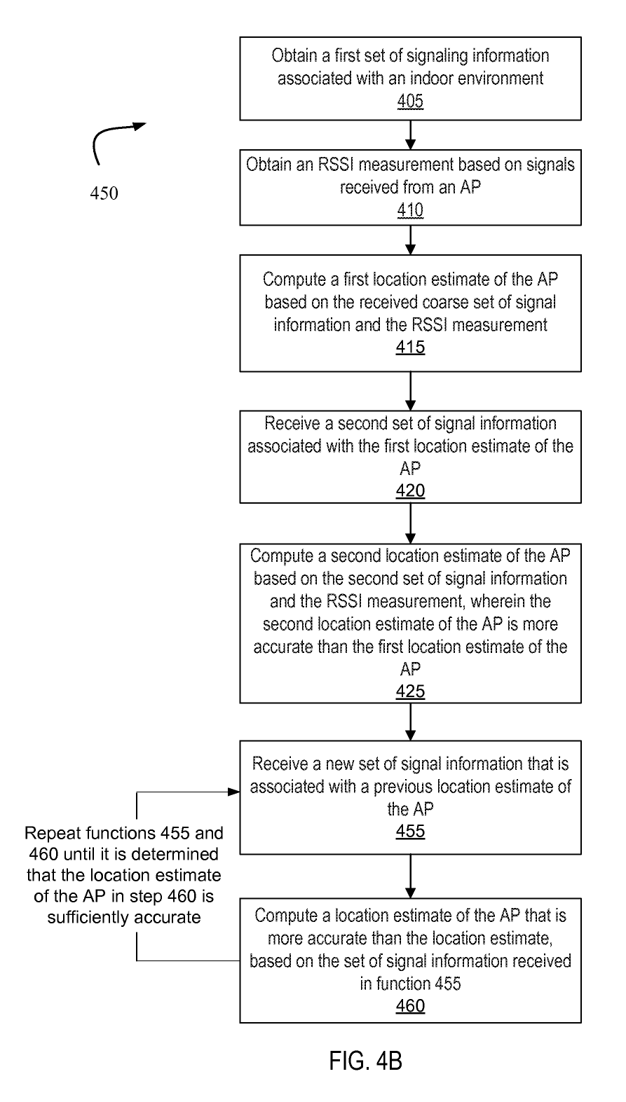

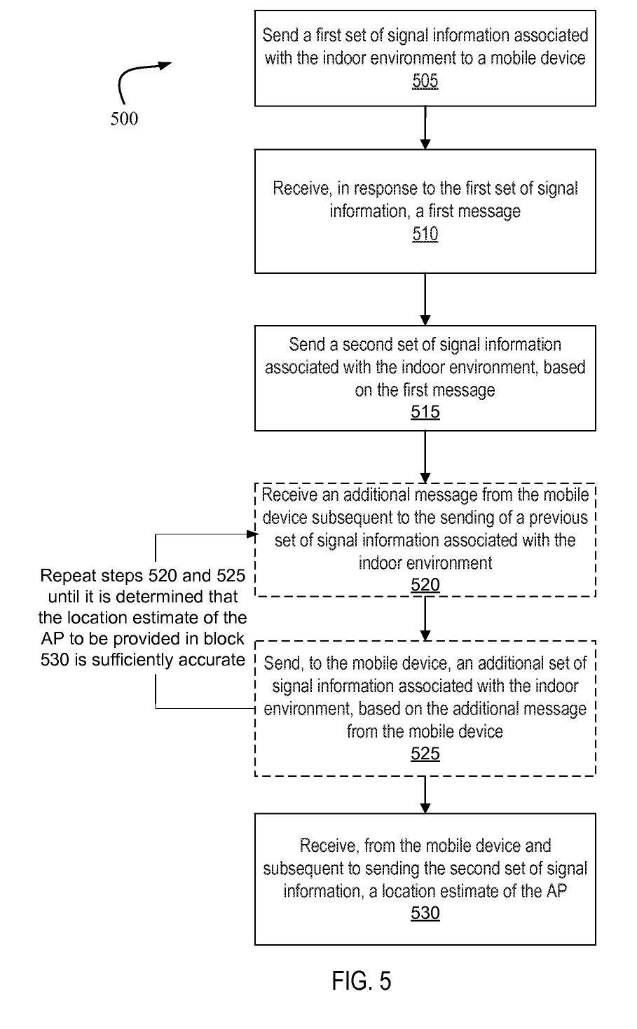

Referring to FIG. 4A, flowchart 400 illustrates an example series of method functions for estimating a location of an AP. As provided in FIGS. 4A-5, the term AP refers to an AP having a location unknown or undetermined by a server (there may be additional APs in the indoor environment). The methods described herein may be implemented by various means, including the example apparatuses, systems and processors described in any of FIGS. 1, 2, 3, and 6. For example, the method of flowchart 400 may be implemented by a mobile device 100 acting as a surveyor device as described in embodiments provided previously herein.

At block 405, an example device may obtain a first (e.g., coarse) set of signal information associated with an indoor environment. The signal information may include assistance data of the indoor environment, for example, layout information about the walls, line of sight (LoS) information, and non-line of sight (NLoS) information about the indoor environment. The signal information may additionally include information from the perspective of various locations within the indoor environment. For example, the signal information may be based on the perspectives of various centroids within a square or rectangular grid spread throughout the indoor environment.

At block 410, the example device may an RSSI measurement based on signals received from the AP. The RSSI measurement may be one of a plurality of RSSI measurements, which may include one or more measurements traveling in a direct path to the device, and may also include one or more measurements traveling in one or more non-direct paths, based on reflections and/or diversions due to walls and other physical impediments.

At block 415, the example device may compute a first location estimate of the AP based on the received first set of signal information and the RSSI measurement. An example process for computing the location estimate may be based on computer programs configured to solve the optimization problems described in the above disclosure. In some embodiments, the first location estimate of the AP may be transmitted to a server or other centralized processor with knowledge or access to knowledge about the signaling properties of the indoor environment. Additionally or alternatively, the first location estimate of the AP may be used to determine a request for an additional (e.g., fine) set of signal information, which may be sent to a server or other centralized processor.

At block 420, the example device may then receive a second (e.g., fine) set of signal information associated with the first location estimate of the AP. In some embodiments, the second set of signal information may be based on an area (e.g., the grid 310 of FIG. 3) fully encompassed by the area covered in the first set of signal information (e.g., the grid 210 of FIG. 2). In other words, the second set of signal information may represent a zoomed-in area to the AP compared to the first set of signal information. The type of signal information may be similar to those described in the first set, but just closer in physical proximity overall to the location of the AP.

At block 425, the example device may compute a second location estimate of the AP based on the second set of signal information and the RSSI measurement, wherein the second location estimate of the AP is more accurate than the first location estimate of the AP. Methods to compute the second location estimate may be similar to those used to compute the first location estimate in block 415, except that the data used is closer to the location of the AP overall, and thus the second location estimate is likely to be more accurate than the first location estimate of the AP. In some embodiments, the second location estimate may be transmitted to a server or other central repository.

Referring to FIG. 4B, flowchart 450 illustrates another example series of functions for estimating a location of an AP, according to some embodiments. The methods described herein may be implemented by various means, including the example apparatuses, systems and processors described in any of FIGS. 1, 2, 3, and 6. For example, the method of flowchart 450 may be implemented by a mobile device 100. Flowchart 450 includes the same functions described in FIG. 4A, but with additional functions.

Thus, block 455 proceeds after computing a location estimate of the AP. At block 455, the example device may receive a new set of signal information that is associated with the previous location estimate of the AP. In a first instance of block 455, the previous location estimate would therefore be the second location estimate of block 425. The new set of signal information in block 455 would therefore be even finer in detail than the second set of signal information in block 420, because it would be based on a more accurate location estimate (the location estimate of block 425). For example, the new set of signal information may be associated with a “zoomed-in” grid of signal information compared to the second set of signal information. (For example, where the first set of signal information is associated with grid 210 of FIG. 2 and the second set of signal information is associated with the grid 310 of FIG. 3, the new set of signal information can be associated with a grid that is even smaller than grid 310 of FIG. 3—covering, for example, a subset of the area covered by the grid 310.) In later iterations, described below, an even finer set of signal information may be received than any set of signal information previously received, and so forth.

At block 460, the example device may compute a location estimate of the AP that is more accurate than the previous location estimate, based on the set of signal information received in block 455. A process for computing this at least one estimate may be similar to those described in blocks 425 and 415, except that the set of signal information used is even closer in physical proximity to the location of the AP, and thus should be even more accurate.

The functions in 455 and 460 may be repeated in an iterative loop until it is determined that the at least one location estimate of the AP in function 460 is sufficiently accurate. The determination of whether the location estimate is sufficiently accurate may be based on a predetermined threshold criterion. For example, the location estimate may be sufficiently accurate when the latest set of signal information includes location points that are one foot apart from each other. Other example criteria are described in the disclosures herein, and others are certainly possible according to those with skill in the art. Once a location estimate of the AP is sufficiently accurate, the final location estimate may be transmitted to a server or other central repository. For embodiments in which a location estimate is provided to the server after each iteration, the server may determine that the estimate is sufficiently accurate.

Referring to FIG. 5, flowchart 500 illustrates example functions for estimating the location of an AP, based on the perspective of a server or other central repository with knowledge of signal information within the indoor environment. One should be able to see an interrelationship between the functions described in FIG. 5 and the functions described in FIGS. 4A and 4B. The methods described herein may be implemented by various means, including the example apparatuses, systems and processors described in any of FIGS. 1, 2, 3, and 6. For example, a location server can execute one or more of the functions shown in FIG. 5.

At block 505, an example server may send a first set of signal information associated with an indoor environment. The first set of signal information may include information consistent with those described in block 505, for example. The first set of signal information may be sent to a mobile device requesting such information, such as a surveyor device or a mobile device roaming the indoor environment.

At block 510, the example server may receive, in response to the first set of signal information, a first message from the mobile device. The message can be received from a mobile device (e.g., the mobile device to which the first set of signal information was sent in block 505). As detailed in the embodiments provided above, the message can include an initial location estimate. Additionally or alternatively, the message can include a request for a second set of signal information.

At block 515, the example server may send a second set of signal information associated with the indoor environment, based on the first message. The second set of signal information may be based on an area in the indoor environment that is encompassed by the area covered by the first set of signal information. In other words, the first set of signal information relate to a first area associated with the indoor environment, and the second set of signal information can relate to a second area associated with the indoor environment, where the first area is larger than the second area and fully encompasses the second area.

In some embodiments, the process 500 may include an iterative loop comprising blocks 520 and 525. Thus, at block 520, in some embodiments, the example server may receive an additional message from the mobile device, subsequent to the sending of a previous set of signal information associated with the indoor environment. In a first instance of entering block 520, the previous set of signal information would be the second set of signal information provided in block 515. In later iterations, when re-entering block 520, even finer sets of information would be provided.

At block 525, the example server may send, to the mobile device, an additional set of signal information associated with the indoor environment, based on the additional message from the mobile device. Functions 520 and 525 may be repeated until it is determined that location estimate of the AP to be provided in function 530 is sufficiently accurate, based on a predetermined threshold criterion. For embodiments in which messages from the mobile device include a location estimate, the server may make this determination. For some embodiments, the mobile device may make this determination.

At block 530, the example server may receive a location estimate of the AP. The location estimate is received subsequent to sending the second set of signal information. In some embodiments, the location estimate is received subsequent to performing the functions of blocks 520 and 525. In some embodiments, this completes the process for estimating the location of the AP. The server may then include the estimated location in a repository, propagate the estimated location to other mobile devices, or the like.

Many embodiments may be made in accordance with specific requirements. For example, customized hardware might also be used, and/or particular elements might be implemented in hardware, software (including portable software, such as applets, etc.), or both. Further, connection to other computing devices such as network input/output devices may be employed.

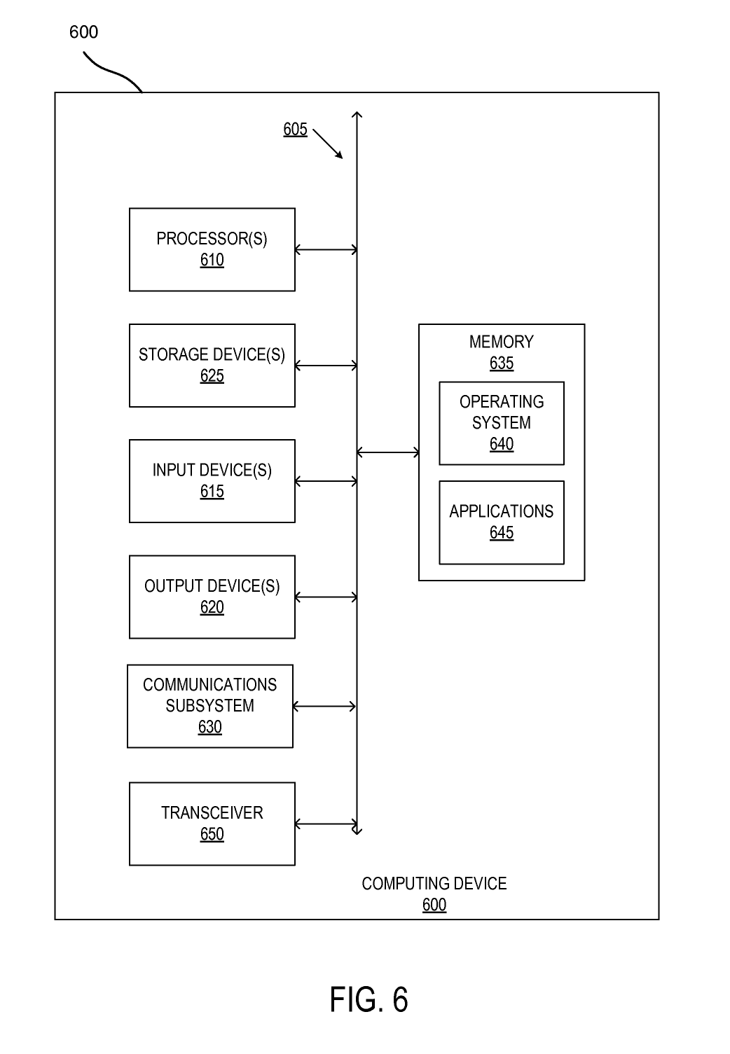

Having described multiple aspects of estimating a location of an AP in an indoor environment, an example of a computing system in which various aspects of the disclosure may be implemented will now be described with respect to FIG. 6. According to one or more aspects, a computer system as illustrated in FIG. 6 may be incorporated as part of a location server and/or AP as detailed in the embodiments described herein. In some embodiments, the system 600 is configured to implement any of the methods described above. FIG. 6 is meant only to provide a generalized illustration of various components, any and/or all of which may be utilized as appropriate. FIG. 6, therefore, broadly illustrates how individual system elements may be implemented in a relatively separated or relatively more integrated manner.

The computer system 600 is shown comprising hardware elements that can be electrically coupled via a bus 605 (or may otherwise be in communication, as appropriate). The hardware elements may include one or more processors 610, including without limitation one or more general-purpose processors and/or one or more special-purpose processors (such as digital signal processing chips, graphics acceleration processors, and/or the like); one or more input devices 615, which can include without limitation a camera, wireless receivers, wireless sensors, a mouse, a keyboard and/or the like; and one or more output devices 620, which can include without limitation a display unit, a printer and/or the like. In some embodiments, the one or more processor 610 may be configured to perform a subset or all of the functions described above with respect to FIGS. 4A, 4B, and/or 5. The processor 610 may comprise a general processor and/or and application processor, for example. In some embodiments, the processor is integrated into an element that processes visual tracking device inputs and wireless sensor inputs.

The computer system 600 may further include (and/or be in communication with) one or more non-transitory storage devices 625, which can comprise, without limitation, local and/or network accessible storage, and/or can include, without limitation, a disk drive, a drive array, an optical storage device, a solid-state storage device such as a random access memory (“RAM”) and/or a read-only memory (“ROM”), which can be programmable, flash-updateable and/or the like. Such storage devices may be configured to implement any appropriate data storage, including without limitation, various file systems, database structures, and/or the like.

The computer system 600 might also include a communications subsystem 630, which can include without limitation a modem, a network card (wireless or wired), an infrared communication device, a wireless communication device and/or chipset (such as a Bluetooth® device, an 802.11 device, a WiFi device, a WiMax device, cellular communication facilities, etc.), and/or the like. The communications subsystem 630 may permit data to be exchanged with a network (such as the network described below, to name one example), other computer systems, and/or any other devices described herein. In many embodiments, the computer system 600 will further comprise a non-transitory working memory 635, which can include a RAM or ROM device, as described above. In some embodiments, communications subsystem 630 may interface with transceiver(s) 650 configured to transmit and receive signals from access points or mobile devices. Some embodiments may include a separate receiver or receivers, and a separate transmitter or transmitters.

The computer system 600 also can comprise software elements, shown as being currently located within the working memory 635, including an operating system 640, device drivers, executable libraries, and/or other code, such as one or more application programs 645, which may comprise computer programs provided by various embodiments, and/or may be designed to implement methods, and/or configure systems, provided by other embodiments, as described herein. Merely by way of example, one or more procedures described with respect to the method(s) discussed above, for example as described with respect to FIGS. 4A, 4B, and/or 5, might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a computer-readable storage medium, such as the storage device(s) 625 described above. In some cases, the storage medium might be incorporated within a computer system, such as computer system 600. In other embodiments, the storage medium might be separate from a computer system (e.g., a removable medium, such as a compact disc), and/or provided in an installation package, such that the storage medium can be used to program, configure and/or adapt a general purpose computer with the instructions/code stored thereon. These instructions might take the form of executable code, which is executable by the computer system 600 and/or might take the form of source and/or installable code, which, upon compilation and/or installation on the computer system 600 (e.g., using any of a variety of generally available compilers, installation programs, compression/decompression utilities, etc.) then takes the form of executable code.

Substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

Some embodiments may employ a computer system (such as the computer system 600) to perform methods in accordance with the disclosure. For example, some or all of the procedures of the described methods may be performed by the computer system 600 in response to processor 610 executing one or more sequences of one or more instructions (which might be incorporated into the operating system 640 and/or other code, such as an application program 645) contained in the working memory 635. Such instructions may be read into the working memory 635 from another computer-readable medium, such as one or more of the storage device(s) 625. Merely by way of example, execution of the sequences of instructions contained in the working memory 635 might cause the processor(s) 610 to perform one or more procedures of the methods described herein, for example methods described with respect to FIGS. 4A, 4B, and/or 5.

The terms “machine-readable medium” and “computer-readable medium,” as used herein, refer to any medium that participates in providing data that causes a machine to operate in a specific fashion. In an embodiment implemented using the computer system 600, various computer-readable media might be involved in providing instructions/code to processor(s) 610 for execution and/or might be used to store and/or carry such instructions/code (e.g., as signals). In many implementations, a computer-readable medium is a physical and/or tangible storage medium. Such a medium may take many forms, including but not limited to, non-volatile media, volatile media, and transmission media. Non-volatile media include, for example, optical and/or magnetic disks, such as the storage device(s) 625. Volatile media include, without limitation, dynamic memory, such as the working memory 635. Transmission media include, without limitation, coaxial cables, copper wire and fiber optics, including the wires that comprise the bus 605, as well as the various components of the communications subsystem 630 (and/or the media by which the communications subsystem 630 provides communication with other devices). Hence, transmission media can also take the form of waves (including without limitation radio, acoustic and/or light waves, such as those generated during radio-wave and infrared data communications).

Common forms of physical and/or tangible computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, EPROM, a FLASH-EPROM, any other memory chip or cartridge, a carrier wave as described hereinafter, or any other medium from which a computer can read instructions and/or code.

Various forms of computer-readable media may be involved in carrying one or more sequences of one or more instructions to the processor(s) 610 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 600. These signals, which might be in the form of electromagnetic signals, acoustic signals, optical signals and/or the like, are all examples of carrier waves on which instructions can be encoded, in accordance with various embodiments of the invention.

The communications subsystem 630 (and/or components thereof) generally will receive the signals, and the bus 605 then might carry the signals (and/or the data, instructions, etc. carried by the signals) to the working memory 635, from which the processor(s) 610 retrieves and executes the instructions. The instructions received by the working memory 635 may optionally be stored on a non-transitory storage device 625 either before or after execution by the processor(s) 610. Memory 635 may contain at least one database according to any of the databases and methods described herein. Memory 635 may thus store any of the values discussed in any of the present disclosures, including any of the figures and related descriptions.

The methods described in FIGS. 4A, 4B, and/or 5 may be implemented by various blocks in FIG. 6. For example, processor 610 may be configured to perform any of the functions of blocks in flowcharts 400, 450, and/or 500. Storage device 625 may be configured to store an intermediate result, such as a globally unique attribute or locally unique attribute discussed within any of blocks mentioned herein. Storage device 625 may also contain a database consistent with any of the present disclosures. The memory 635 may similarly be configured to record signals, representation of signals, or database values necessary to perform any of the functions described in any of the blocks mentioned herein. Results that may need to be stored in a temporary or volatile memory, such as RAM, may also be included in memory 635, and may include any intermediate result similar to what may be stored in storage device 625. Input device 615 may be configured to receive wireless signals from satellites and/or base stations according to the present disclosures described herein. Output device 620 may be configured to display images, print text, transmit signals and/or output other data according to any of the present disclosures.

The methods, systems, and devices discussed above are examples. Various embodiments may omit, substitute, or add various procedures or components as appropriate. For instance, in alternative configurations, the methods described may be performed in an order different from that described, and/or various stages may be added, omitted, and/or combined. Also, features described with respect to certain embodiments may be combined in various other embodiments. Different aspects and elements of the embodiments may be combined in a similar manner. Also, technology evolves and, thus, many of the elements are examples that do not limit the scope of the disclosure to those specific examples.

Specific details are given in the description to provide a thorough understanding of the embodiments. However, embodiments may be practiced without these specific details. For example, well-known circuits, processes, algorithms, structures, and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing embodiments of the invention. Various changes may be made in the function and arrangement of elements without departing from the spirit and scope of the invention.

Also, some embodiments were described as processes depicted as flow diagrams or block diagrams. Although each may describe the operations as a sequential process, many of the operations can be performed in parallel or concurrently. In addition, the order of the operations may be rearranged. A process may have additional functions not included in the figure. Furthermore, embodiments of the methods may be implemented by hardware, software, firmware, middleware, microcode, hardware description languages, or any combination thereof. When implemented in software, firmware, middleware, or microcode, the program code or code segments to perform the associated tasks may be stored in a computer-readable medium such as a storage medium. Processors may perform the associated tasks.

Having described several embodiments, various modifications, alternative constructions, and equivalents may be used without departing from the spirit of the disclosure. For example, the above elements may merely be a component of a larger system, wherein other rules may take precedence over or otherwise modify the application of the invention. Also, a number of functions may be performed before, during, or after the above elements are considered. Accordingly, the above description does not limit the scope of the disclosure.

The techniques described herein may be used for mobile device or client access to various wireless communication networks such as Code Division Multiple Access (CDMA) networks, Time Division Multiple Access (TDMA) networks, Frequency Division Multiple Access (FDMA) networks, Orthogonal FDMA (OFDMA) networks, Single-Carrier FDMA (SC-FDMA) networks, etc. The terms “networks” and “systems” are often used interchangeably. A CDMA network may implement a radio technology such as Universal Terrestrial Radio Access (UTRA), CDMA2000, etc. UTRA includes Wideband-CDMA (W-CDMA) and Low Chip Rate (LCR). CDMA2000 covers IS-2000, IS-95, IS-856 and High Rate Packet Data (HRPD) standards. A TDMA network may implement a radio technology such as Global System for Mobile Communications (GSM). An OFDMA network may implement a radio technology such as Evolved UTRA (E-UTRA), IEEE 802.11, IEEE 802.16, IEEE 802.20, Flash-OFDM®, etc. UTRA is part of Universal Mobile Telecommunication System (UMTS). Long Term Evolution (LTE) is a radio access technology used by E-UTRA. UTRA, E-UTRA, GSM, UMTS and LTE are described in documents from an organization named “3rd Generation Partnership Project” (3GPP). CDMA2000 is described in documents from an organization named “3rd Generation Partnership Project 2” (3GPP2). IEEE 802.11 networks are also known as WiFi networks or wireless local area networks (WLANs) and are defined in a family of standards from the Institute of Electrical and Electronics Engineers (IEEE). These various radio technologies and standards are known in the art.

Various examples have been described. These and other examples are within the scope of the following claims.

What is claimed is:

1. A method for estimating a location of an access point (AP) associated with an indoor environment, the method comprising:
obtaining a first set of signal information associated with the indoor environment;
obtaining a received signal strength indication (RSSI) measurement based on signals received from the AP;
computing a first location estimate of the AP based on the first set of signal information and the RSSI measurement;
obtaining a second set of signal information associated with the first location estimate of the AP; and
computing a second location estimate of the AP based on the second set of signal information and the RSSI measurement, wherein the second location estimate of the AP is more accurate than the first location estimate of the AP.

2. The method of claim 1, further comprising:
a) in response to computing a previous location estimate of the AP, receiving a set of signal information that is associated with the previous location estimate of the AP;
b) computing a location estimate of the AP that is more accurate than the previous location estimate, based on the set of signal information received in (a); and
c) repeating (a) and (b) until it is determined that the location estimate of the AP computed in (b) is sufficiently accurate, based on a predetermined threshold criterion.

3. The method of claim 1, wherein the first set of signal information and the second set of signal information both comprise information regarding walls, line-of-sight, and non-line-of-sight characteristics of the indoor environment.

4. The method of claim 1, further comprising sending the second location estimate to a location server.

5. The method of claim 1, wherein the first set of signal information comprises information related to a first area associated with the indoor environment, and the second set of signal information comprises information related to a second area associated with the indoor environment, and wherein the first area is larger than the second area and fully encompasses the second area.

6. The method of claim 1, wherein the first set of signal information comprises signal information from a plurality of signaling centroids, the plurality of signaling centroids each positioned at different locations within the indoor environment.

7. The method of claim 6, wherein the plurality of signaling centroids are arranged in a grid-like pattern.

8. A mobile device configured to estimate a location of an access point (AP) within an indoor environment, the mobile device comprising:
a transceiver configured to:
obtain a first set of signal information associated with the indoor environment;
obtain a received signal strength indication (RSSI) measurement based on signals received from the AP; and
receive a second set of signal information associated with a first location estimate of the AP; and
a processor configured to:
compute the first location estimate of the AP based on the first set of signal information and the RSSI measurement; and
compute a second location estimate of the AP based on the second set of signal information and RSSI measurement, wherein the second location estimate of the AP is more accurate than the first location estimate of the AP.

9. The mobile device of claim 8, wherein:
the transceiver is further configured to:
a) in response to a computation of a previous location estimate of the AP, receive a set of signal information that is associated with the previous location estimate of the AP; and
the processor is further configured to:
b) compute a location estimate of the AP that is more accurate than the previous location estimate, based on the set of signal information received in (a);
wherein the mobile device is further configured to repeat (a) and (b) until it is determined that the location estimate of the AP computed in (b) is sufficiently accurate, based on a predetermined threshold criterion.

10. The mobile device of claim 8, wherein the first set of signal information and the second set of signal information both comprise information regarding walls, line-of-sight, and non-line-of-sight characteristics of the indoor environment.

11. The mobile device of claim 8, wherein the transceiver is further configured to send the second location estimate to a location server.

12. The mobile device of claim 8, wherein the first set of signal information comprises information related to a first area associated with the indoor environment, and the second set of signal information comprises information related to a second area associated with the indoor environment, and wherein the first area is larger than the second area and fully encompasses the second area.

13. The mobile device of claim 8, wherein the first set of signal information comprises signal information from a plurality of signaling centroids, the plurality of signaling centroids each positioned at different locations within the indoor environment.

14. The mobile device of claim 13, wherein the plurality of signaling centroids are arranged in a grid-like pattern.

15. A method of facilitating location estimation of an access point (AP) associated with an indoor environment, the method comprising:
sending, to a mobile device, a first set of signal information associated with the indoor environment;
receiving, in response to the first set of signal information, a first message from the mobile device;
sending, to the mobile device, a second set of signal information associated with the indoor environment, based on the first message from the mobile device; and
receiving, from the mobile device and subsequent to sending the second set of signal information, a location estimate of the AP.

16. The method of claim 15, further comprising:
a) receiving an additional message from the mobile device subsequent to the sending of a previous set of signal information associated with the indoor environment; and
b) sending, to the mobile device, an additional set of signal information associated with the indoor environment, based on the additional message from the mobile device;
wherein both (a) and (b) occur after sending the second set of signal information, and prior to receiving the location estimate of the AP.

17. The method of claim 16, wherein (a) and (b) are repeated until it is determined that the location estimate of the AP computed in function (b) is sufficiently accurate, based on a predetermined threshold criterion.

18. The method of claim 15, wherein the first set of signal information and the second set of signal information both comprise information regarding walls, line-of-sight, and non-line-of-sight characteristics of the indoor environment.

19. The method of claim 15, wherein the first message comprises either or both of:
an initial location estimate of the AP, or
a request for the second set of signal information.

20. The method of claim 15, wherein the first set of signal information comprises information related to a first area associated with the indoor environment, and the second set of signal information comprises information related to a second area associated with the indoor environment, and wherein the first area is larger than the second area and fully encompasses the second area.

21. The method of claim 15, wherein the first set of signal information comprises signal information from a plurality of signaling centroids, the plurality of signaling centroids each positioned at different locations within the indoor environment.

22. The method of claim 21, wherein the plurality of signaling centroids are arranged in a grid-like pattern.

23. A server configured to facilitate location estimation of an access point (AP) associated with an indoor environment, the server comprising:
a transceiver;
a memory; and
one or more processors communicatively coupled with the transceiver and the memory, and configured to cause the server to:
send, to a mobile device, a first set of signal information associated with the indoor environment;
receive, in response to the first set of signal information, a first message from the mobile device;
send, to the mobile device, a second set of signal information associated with the indoor environment to the mobile device, based on the first message from the mobile device; and
receive, from the mobile device and subsequent to sending the second set of signal information, a location estimate of the AP.

24. The server of claim 23, wherein the one or more processors are configured to cause the server to:
a) receive an additional message from the mobile device subsequent to the sending of a previous set of signal information associated with the indoor environment; and
b) send, to the mobile device, an additional set of signal information associated with the indoor environment, based on the additional message from the mobile device;
wherein both (a) and (b) occur after sending the second set of signal information, and prior to receiving the location estimate of the AP.

25. The server of claim 24 wherein the one or more processors are configured to cause the server to repeat (a) and (b) until it is determined that the location estimate of the AP computed in function (b) is sufficiently accurate, based on a predetermined threshold criterion.

26. The server of claim 23, wherein the one or more processors are configured to cause the server to send the first set of signal information and the second set of signal information comprising information regarding walls, line-of-sight, and non-line-of-sight characteristics of the indoor environment.

27. The server of claim 23, wherein the one or more processors are configured to cause the server to base the second set of signal information on the first message comprising either or both of:
an initial location estimate of the AP, or
a request for the second set of signal information.

28. The server of claim 23, wherein the one or more processors are configured to cause the server to:
include, in the first set of signal information, information related to a first area associated with the indoor environment; and
include, in the second set of signal information, information related to a second area associated with the indoor environment, wherein the first area is larger than the second area and fully encompasses the second area.

29. The server of claim 23 wherein the one or more processors are configured to cause the server to include, in the first set of signal information, signal information from a plurality of signaling centroids, the plurality of signaling centroids each positioned at different locations within the indoor environment.

30. The server of claim 29, wherein the one or more processors are configured to cause the server to further cause the plurality of signaling centroids to be arranged in a grid-like pattern.
